(19) United States
(12) Patent Application Publication
(10) Pub. No.: US 2021/0224019 A1
(43) Pub. Date: Jul. 22, 2021

(54) DISPLAY APPARATUS AND DISPLAY CONTROL METHOD

(71) Applicant: Panasonic Intellectual Property Corporation of America, Torrance, CA (US)

(72) Inventors: Randall Chang LEU, Cupertino, CA (US); Angelique Camille LANG, San Jose, CA (US); James Philip FAROL-SCHENCK, San Mateo, CA (US)

(21) Appl. No.: 17/220,364

(22) Filed: Apr. 1, 2021

Related U.S. Application Data
(63) Continuation of application No. PCT/US2019/053495, filed on Sep. 27, 2019.
(60) Provisional application No. 62/739,528, filed on Oct. 1, 2018.

(51) Int. Cl. G06F 3/14; G09G 3/20

(52) U.S. Cl. CPC G06F 3/1454; G09G 3/20; G09G 2370/22; G09G 2354/00; G09G 2370/042; G09G 2356/00; G09G 2370/06

(57) ABSTRACT

A display apparatus of the present disclosure includes a housing, a display panel attached to the housing, a sensor located in the housing that detects an existence of another display apparatus, and control circuitry located in the housing. The control circuitry controls notifying a user of the display apparatus of the detected existence of the other display apparatus by at least one of a sound notification, a vibration notification, and a visual notification, and controls initiating transfer of graphic objects that are displayed on a display of the other display apparatus to the display panel when a distance from the display apparatus to the other display apparatus is less than or equal to a first threshold value. The transfer of graphic objects includes displaying one of the graphic objects on the display panel and having the one of the graphic objects deleted from the display of the other display apparatus.

### CROSS REFERENCE TO RELATED APPLICATIONS

This application is a U.S. continuation application of PCT International Patent Application Number PCT/US2019/053495 filed on Sep. 27, 2019, claiming the benefit of priority of U.S. Provisional Patent Application No. 62/739,528 filed on Oct. 1, 2018, the entire contents of which are hereby incorporated by reference.

### BACKGROUND

### 1. Technical Field

The present disclosure is generally directed to a display apparatus and a display control method.

### 2. Description of the Related Art

Currently, a display panel is widely used to control an electronic device. In a living space, for example, a display panel of an air conditioner is attached on a wall and is used to turn on or off, to adjust the setting temperature, or to change the wind direction. In a vehicle, as another example, a display panel of an audio system is attached on an interior wall and is used to turn on or off, to adjust the volume, and to change the frequency of AM/FM radio. In an airplane, as another example, a display panel is attached on a back front of each seat and displays various utility and entertainment information for selection by the passenger.

To effectively utilize such a display panel, for example, Japanese Patent No. 6435869 discloses extended display control for displaying predetermined images on a portable terminal and a display of an operation display terminal.

### SUMMARY

A lot of display panels are used in a house, in an office building, in a vehicle or in a plane, while people usually carry their own portable display apparatus such as a tablet PC or a cell phone. Although a method is known to remotely control an electronic device such as an air conditioning system or lighting by using a cell phone, there was no linking or synchronization of the user interfaces (UI) between the semi-fixed display panel and the user's portable display apparatus. This leads to confusion and inconvenience of the user because the user needs to look at both of the display panels to determine which display panel provides the latest information and to ensure that the electronic device is operated as instructed.

In Japanese Patent No. 6435869, when the portable terminal displaying some of the predetermined images is overlapped with the display of the operation display terminal, the remaining predetermined image are displayed on the display of the operation display device but the remaining images are not displayed on the portable terminal. For this reason, the user cannot operate the remaining predetermined images using the portable terminal.

One non-limiting and exemplary embodiment of the present disclosure facilitates providing a display apparatus that can display graphic objects in a seamless manner.

In one general aspect, the techniques disclosed here feature: a display apparatus including a housing, a display panel attached to the housing, a sensor located in the housing that detects an existence of another display apparatus, and control circuitry located in the housing. The control circuitry controls notifying a user of the display apparatus of the detected existence of the other display apparatus by at least one of a sound notification, a vibration notification and a visual notification and controls initiating transfer of graphic objects that are displayed on a display of the other display apparatus to the display panel when a distance from the display apparatus to the other display apparatus is less than or equal to a first threshold value. The transfer of graphic objects includes displaying one of the graphic objects on the display panel and having the one of the graphic objects deleted from the display of the other display apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 illustrates an example of a display apparatus of Embodiment 1;

FIG. 2 illustrates an example structure of a display apparatus of Embodiment 1;

FIG. 3 illustrates an example interaction between a display apparatus and another display apparatus of Embodiment 1;

FIG. 4 shows a diagram of graphic object transfer of Embodiment 1;

FIG. 5A illustrates an example display change of Embodiment 1;

FIG. 5B illustrates an example display change of Embodiment 1;

FIG. 5C illustrates an example display change of Embodiment 1;

FIG. 5D illustrates an example display change of Embodiment 1;

FIG. 6A illustrates another example display change of Embodiment 1;

FIG. 6B illustrates another example display change of Embodiment 1;

FIG. 6C illustrates another example display change of Embodiment 1;

FIG. 6D illustrates another example display change of Embodiment 1;

FIG. 7A illustrates another example display change of Embodiment 1;

FIG. 7B illustrates another example display change of Embodiment 1;

FIG. 7C illustrates another example display change of Embodiment 1;

FIG. 7D illustrates another example display change of Embodiment 1;

FIG. 7E illustrates another example display change of Embodiment 1;

FIG. 7F illustrates another example display change of Embodiment 1;

FIG. 8 illustrates an example of a display apparatus of Embodiment 2;

FIG. 9 illustrates an example structure of a display apparatus of Embodiment 2;

FIG. 10 illustrates an example interaction between a display apparatus and another display apparatus of Embodiment 2;

FIG. 11A illustrates an example display change of Embodiment 2;

FIG. 11B illustrates an example display change of Embodiment 2;

FIG. 11C illustrates an example display change of Embodiment 2;

FIG. 11D illustrates an example display change of Embodiment 2;

FIG. 11E illustrates an example display change of Embodiment 2;

FIG. 11F illustrates an example display change of Embodiment 2;

FIG. 12 illustrates an example interaction between a display apparatus and another display apparatus of Embodiment 3; and

FIG. 13 illustrates an example structure of a display apparatus of Embodiments 1, 2, and 3.

### DETAILED DESCRIPTION OF THE EMBODIMENTS

Hereinafter, exemplary embodiments will be described in detail with reference to the Drawings.

Note that each of the exemplary embodiments described below shows a general or specific example. The numerical values, shapes, materials, structural components, the arrangement and connection of the structural components, steps, the processing order of the steps, etc., are mere examples, and thus are not intended to limit the present disclosure.

Furthermore, the respective figures are not necessarily precise illustrations. In the figures, the same reference signs are given to substantially identical elements, and overlapping description is omitted or simplified.

### Embodiment 1

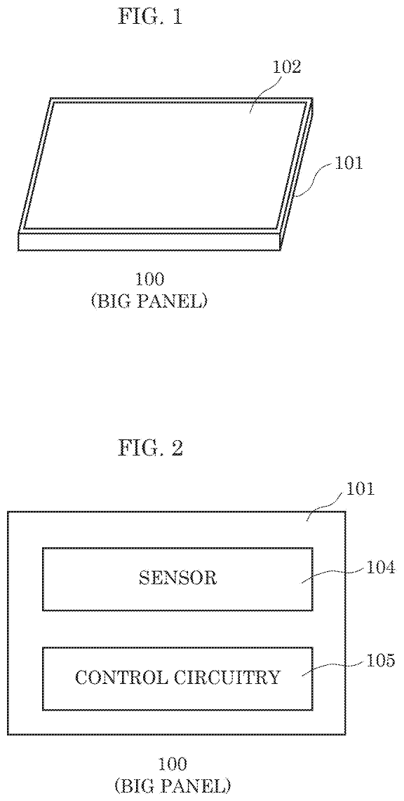

FIG. 1 illustrates an example of display apparatus 100 of Embodiment 1 of the present disclosure. Display apparatus 100 of FIG. 1 includes housing 101 and display panel 102. Display apparatus 100 can be referred to as a “Big Panel” to distinguish from another display apparatus (Mini Panel) in this embodiment.

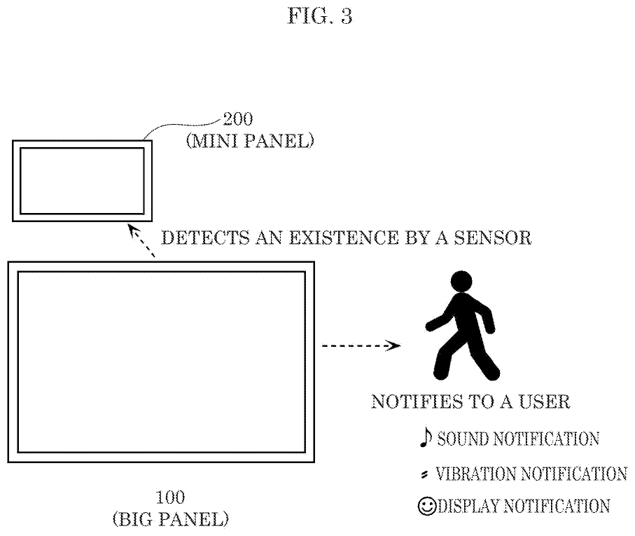

FIG. 2 illustrates an example structure of housing 101 of FIG. 1. As illustrated in FIG. 2, sensor 104 and control circuitry 105 are located inside housing 101. However, locations of sensor 104 and control circuitry 105 are not limited to this example.

FIG. 3 illustrates an example interaction between display apparatus (Big Panel) 100 and another display apparatus (can be referred to as a “Mini Panel”) 200 of Embodiment 1. Display apparatus 100 can be, for example, a tablet PC or a display pad. The other display apparatus (Mini Panel) 200 can be a small display panel attached on a wall and is used, for example, to turn on or off a light or to adjust a volume of an audio device. In this embodiment, the display size of display apparatus (Big Panel) 100 is larger than the display size of the other display apparatus (Mini Panel) 200. The display size can be determined by the length of the sides or area of the display.

When sensor 104 of FIG. 2 detects an existence of the other display apparatus 200, control circuitry 105 of FIG. 2 notifies the user of display apparatus 100 of the existence of the other display apparatus by sound notification, vibration notification or display notification. Sensor 104 of FIG. 2 detects the existence of the other display apparatus 200 by using an infrared sensor, radar, a photo sensor or other known techniques. Display apparatus 100 can make a noise for notification, or vibrate housing 101, or display specified information on display panel 102 such as “Another panel is close by”. Display apparatus 100 can use two or more of these notification methods at the same time. The user of display apparatus 100 can change the setting for this notification by selecting one of these notification methods. These are only an example of notification method and the method and timing of the notification is not limited to the above explanation.

It should be noted that the user of display apparatus 100 can be the owner or the user of the other display apparatus 200. Thus, in this embodiment, the term “the user of display apparatus 100 (Big Panel)” can be replaced with the term “the user of display apparatus 200 (Mini Panel)”.

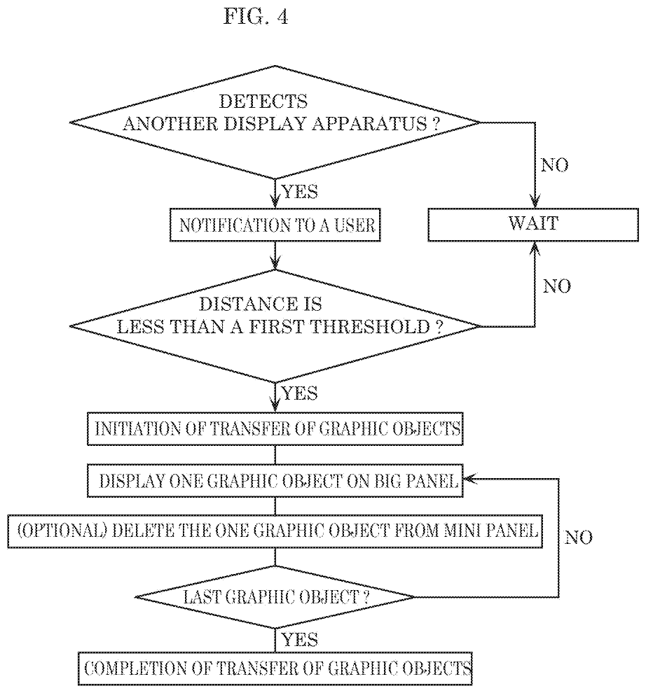

FIG. 4 shows a diagram of graphic object transfer of Embodiment 1. When sensor 104 detects another display apparatus 200, it notifies the existence to the user by sound notification, vibration notification or display notification. Otherwise, display apparatus 100 just waits. When sensor 104 further detects that the distance to the other display apparatus 200 is less than a first threshold value, control circuitry 105 initiates transfer of graphic objects that are displayed on the other display apparatus 200. The first threshold value can be set to one inch, for example, or can be set to an arbitrary value by the user. The transfer of graphic objects is performed by repeating: reception of object data of one of the graphic objects from the other display apparatus (Mini Panel) 200; displaying the one of the graphic objects on the display apparatus (Big Panel) 100 based on the received data; and optionally deleting the one of the graphic objects from the display of the other display apparatus (Mini Panel) 200. This process is performed by graphic object unit. When all of the graphic objects are displayed on display apparatus (Big Panel) 100, the transfer of graphic objects is completed. Here, the graphic objects may include at least one of a graphic icon, a text message, a picture, a graphical illustration and a combination thereof.

It should be noted that a transfer process performed by graphic object unit means that transferring graphic objects individually is permitted but transferring only a portion of a single graphic object is prohibited. In this case, a graphic object cannot be displayed divided between display apparatus 100 and the other display apparatus 200. Moreover, in the transfer process performed by graphic object unit, simultaneously transferring 2 or more graphic objects is permitted.

Although it is optional, the one of the graphic objects may be deleted from the display of the other display apparatus (Mini Panel) 200 when it is displayed by the display apparatus (Big Panel) 100. This deletion may be instructed by control circuitry 105 of the display apparatus (Big Panel) 100 by sending an instruction signal to the other display apparatus (Mini Panel) 200 and be performed by the other display apparatus (Mini Panel) 200. This synchronization of UI transfer and UI deletion may be implemented by using an application software. This deletion of a graphic object (UI) from the other display apparatus 200 facilitates displaying graphic objects (UIs) in a seamless manner. In other words, the user does not need to look at both of Big Panel 100 and Mini Panel 200 to determine which panel provides the latest information, thus decreasing confusion and inconvenience of the user. It should be noted that the deletion of one graphic object may be completed in a second or may be performed by gradual fading of the color and brightness of the one graphic object. Or it may be performed by deleting components (e.g., a frame portion, a text portion and a graphic icon portion) of the one graphic object one by one.

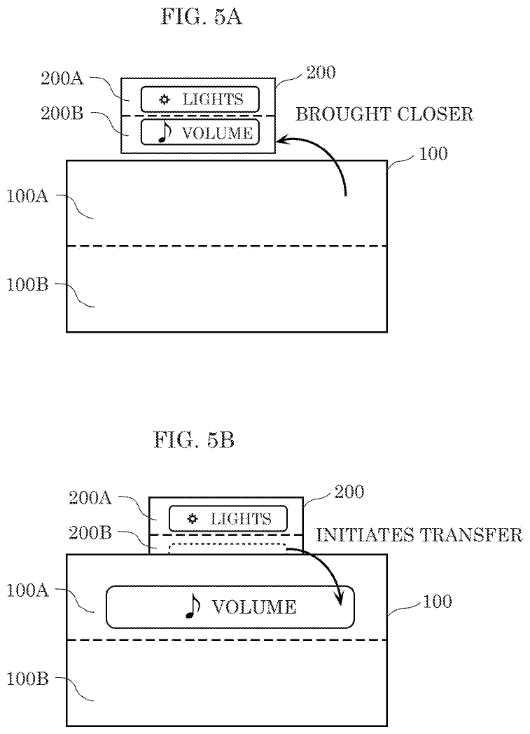

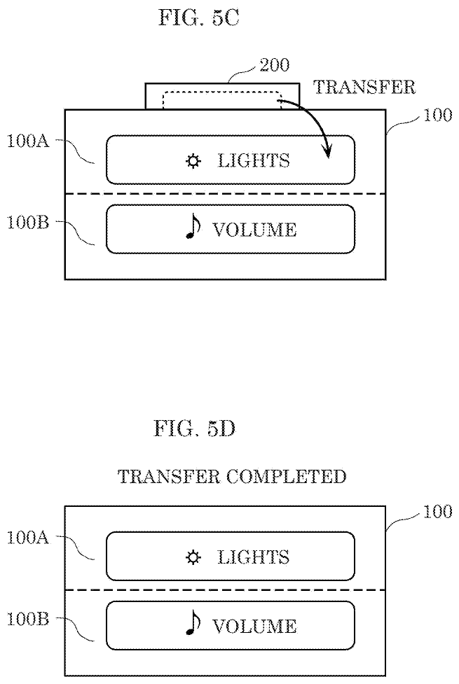

FIG. 5A to FIG. 5D illustrate an example display change of Embodiment 1. When Big Panel 100 is brought closer to Mini Panel 200 from downward as illustrated in FIG. 5A, and one of the graphic objects (e.g., Volume icon) on lower portion 200B of Mini Panel 200 is about to be covered by Big Panel 100, the Volume icon will be displayed on upper portion 100A of Big Panel 100 and will be deleted from Mini Panel 200 (FIG. 5B). When the other graphic object (e.g., Lights icon) on upper portion 200A of Mini Panel 200 is about to be further covered by Big Panel 100, the Lights icon will be displayed on upper portion 100A of Big Panel 100 and the Volume icon will be moved to lower portion 100B of Big Panel 100 (FIG. 5C). When Big Panel 100 is placed in front of or mounted over Mini Panel 200 and the Lights icon is deleted from Mini Panel 200, the transfer of graphic objects is completed (FIG. 5D).

In FIG. 5A to FIG. 5D, upper portion 100A and lower portion 100B of Big Panel 100 correspond respectively to the first portion and the second portion of the display panel. Upper portion 200A and lower portion 200B of Mini Panel 200 correspond respectively to the third portion and the fourth portion of the other display apparatus.

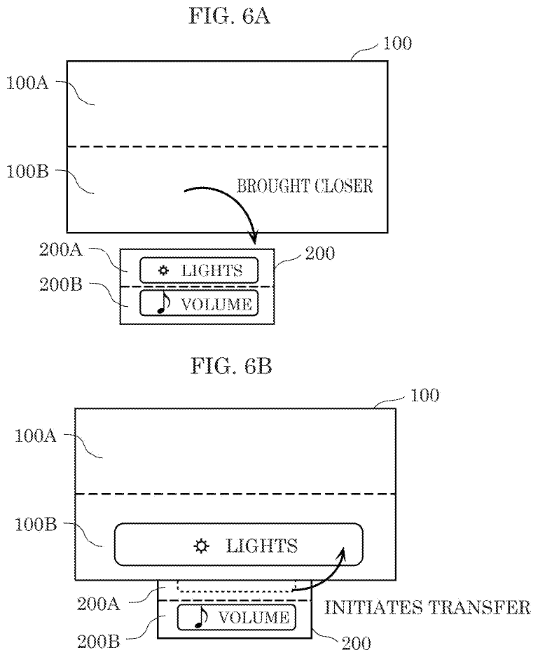

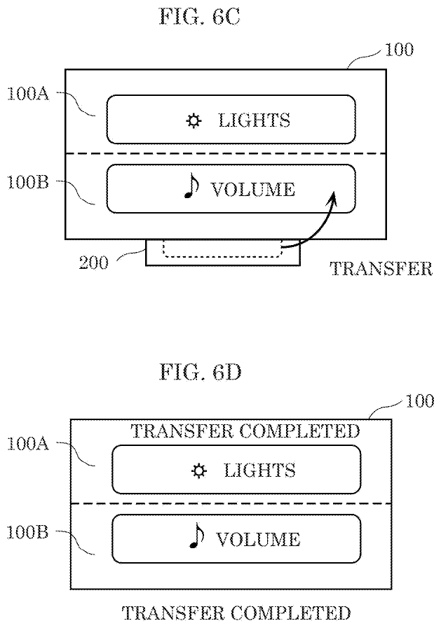

FIG. 6A to FIG. 6D illustrate another example display change of Embodiment 1. When Big Panel 100 is brought closer to Mini Panel 200 from upward as illustrated in FIG. 6A, and one of the graphic objects (e.g., Lights icon) on upper portion 200A of Mini Panel 200 is about to be covered by Big Panel 100, the Lights icon will be displayed on lower portion 100B of Big Panel 100 and it will be deleted from Mini Panel 200 (FIG. 6B). When the other graphic object (e.g., Volume icon) on lower portion 200B of Mini Panel 200 is about to be further covered by Big Panel 100, the Volume icon will be displayed on lower portion 100B of Big Panel 100 and the Lights icon will be moved to upper portion 100A of Big Panel 100 (FIG. 6C). When Big Panel 100 is placed in front of or mounted over Mini Panel 200 and the Volume icon is deleted from Mini Panel 200, the transfer of graphic objects is completed (FIG. 6D).

In FIG. 6A to FIG. 6D, upper portion 100A and lower portion 100B of Big Panel 100 correspond respectively to the second portion and the first portion of the display panel. Upper portion 200A and lower portion 200B of Mini Panel 200 correspond respectively to the fourth portion and the third portion of the other display apparatus.

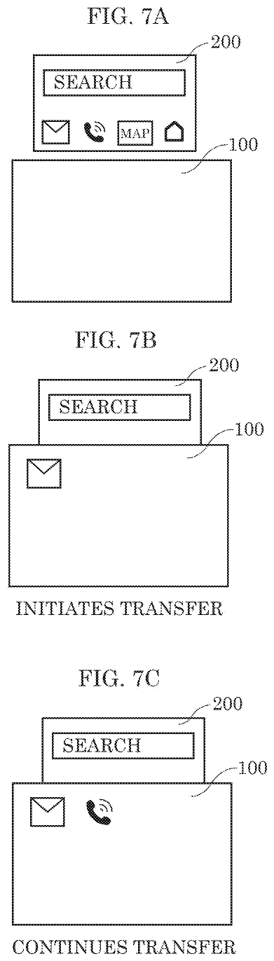

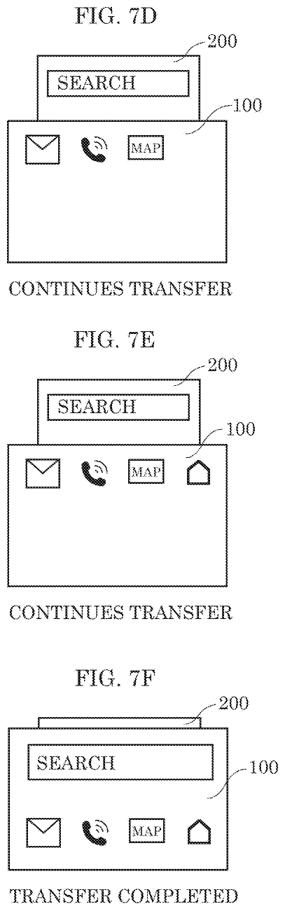

FIG. 7A to FIG. 7F illustrate another example display change of Embodiment 1. When Big Panel 100 is brought closer to Mini Panel 200 from downward as illustrated in FIG. 7A, and the lower portion of Mini Panel 200 that displays a plurality of graphic objects is about to be covered by Big Panel 100, one of the graphic objects (e.g., Mail icon) will be displayed on the upper left portion of Big Panel 100 and it will be deleted from Mini Panel 200 (FIG. 7B). Then, another one of the graphic objects (e.g., Telephone icon) will be displayed on the upper middle portion of Big Panel 100 and it will be deleted from Mini Panel 200 (FIG. 7C). Next, another one of the graphic objects (e.g., Map icon) will be displayed on the upper middle portion of Big Panel 100 and it will be deleted from Mini Panel 200 (FIG. 7D). Then, last one of the graphic objects (e.g., House icon) will be displayed on the upper right portion of Big Panel 100 and it will be deleted from Mini Panel 200 (FIG. 7E). After that, when the remaining graphic object(s) that is displayed on the upper portion of Mini Panel 200 (e.g., Search icon) is about to be further covered by Big Panel 100, the Search icon will be displayed on the upper portion of Big Panel 100 and the other icons (Mail, Telephone, Map and House icons) will be moved to the lower portion of Big Panel 100 (FIG. 7F). When Big Panel 100 is placed in front of or mounted over Mini Panel 200 and all of the graphic objects (icons) are deleted from Mini Panel 200, the transfer of graphic objects is completed. It should be noted that because the deletion of the graphic objects is optional, some of the graphic objects, such as a search icon, that are originally displayed on Mini Panel 200 can remain on the display of Mini Panel 200 in the above described example display changes (FIG. 5A to FIG. 5D, FIG. 6A to FIG. 6D and FIG. 7A to FIG. 7F).

Further, a size and shape of each one of the graphic objects after the transfer may be the same as or different from its original size and shape before the transfer. The size and shape may be adjusted according to the display size of Big Panel 100 to enhance visibility to the user. And the positional relationship of the graphic objects after the transfer can be the same as or different from its original locations on Mini Panel 200.

According to the above described Embodiment 1, graphic objects (UIs) displayed on Mini Panel 200 are transferred to Big Panel 100, thus facilitating to provide a display apparatus that can display graphic objects in a seamless manner. This decreases confusion and inconvenience of the user and enhances user experience when using a semi-fixed display panel and the user's portable display apparatus at the same time.

### Embodiment 2

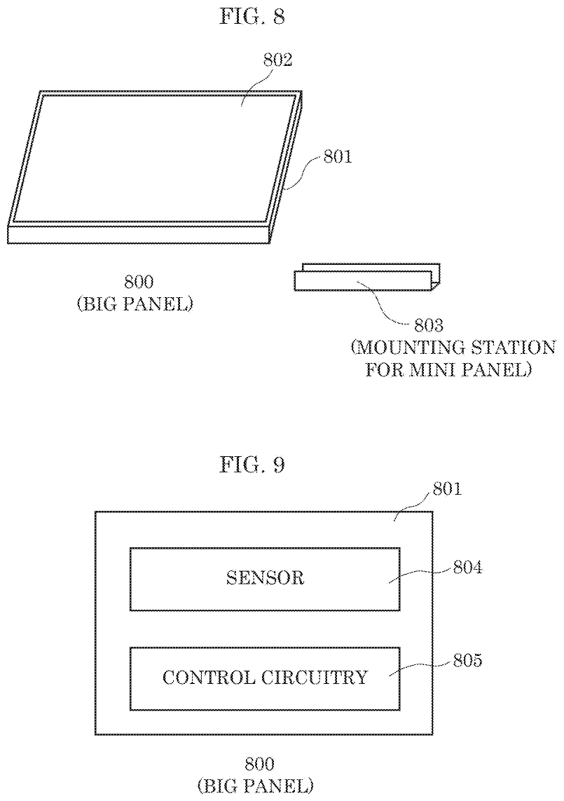

FIG. 8 illustrates an example of display apparatus 800 of Embodiment 2 of the present disclosure. Display apparatus 800 of FIG. 8 includes housing 801 and display panel 802. Display apparatus 800 can be referred to as a “Big Panel” to distinguish from another display apparatus (Mini Panel) in this embodiment. Display apparatus 800 of FIG. 8 may further include mounting station 803 for a Mini Panel.

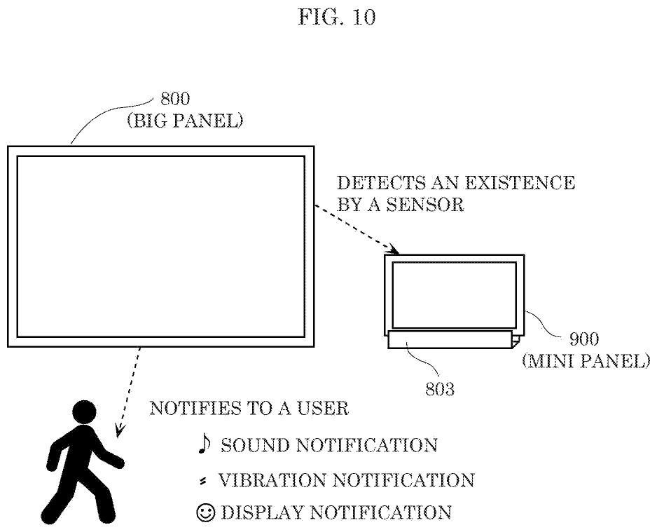

FIG. 9 illustrates an example structure of housing 801 of FIG. 8. As illustrated in FIG. 9, sensor 804 and control circuitry 805 are located inside housing 801. However, locations of sensor 804 and control circuitry 805 are not limited to this example.

FIG. 10 illustrates an example interaction between display apparatus (Big Panel) 800 and another display apparatus (can be referred to as a “Mini Panel”) 900 of Embodiment 2. Display apparatus 800 can be, for example, a desktop PC, a portable PC, a TV, a display panel attached on an interior wall of a vehicle, or a display panel attached on a back front of each seat in an airplane. The other display apparatus (Mini Panel) 200900 can be a tablet PC, a cell phone or a smart phone. In this embodiment, the display size of display apparatus (Big Panel) 800 is larger than the display size of the other display apparatus (Mini Panel) 900. The display size can be determined by the length of the sides or area of the display.

When sensor 804 of FIG. 9 detects an existence of the other display apparatus 900, control circuitry 805 of FIG. 9 notifies the user of display apparatus 800 of the existence of the other display apparatus 900 by sound notification, vibration notification or display notification. Display apparatus 800 can make a noise for notification, or vibrate housing 801, or display specified information on display panel 802 such as “Another panel is close by”. Display apparatus 800 can use two or more of these notification methods at the same time. The user of display apparatus 800 can change the setting for this notification by selecting one of these notification methods. These are only an example of notification method and the method and timing of the notification is not limited to the above explanation.

It should be noted that the user of display apparatus 800 can be the owner or the user of the other display apparatus 900. Thus, in this embodiment, the term “the user of display apparatus 800 (Big Panel) 800” can be replaced by the term “the user of the display apparatus 900 (Mini Panel) 900”.

The process of the graphic object transfer of Embodiment 2 is similar to the one described in Embodiment 1 by using FIG. 4. Thus, FIG. 4 also shows a diagram of graphic object transfer of Embodiment 2. Detailed description of graphic object transfer illustrated in FIG. 4 is omitted for brevity of the explanation.

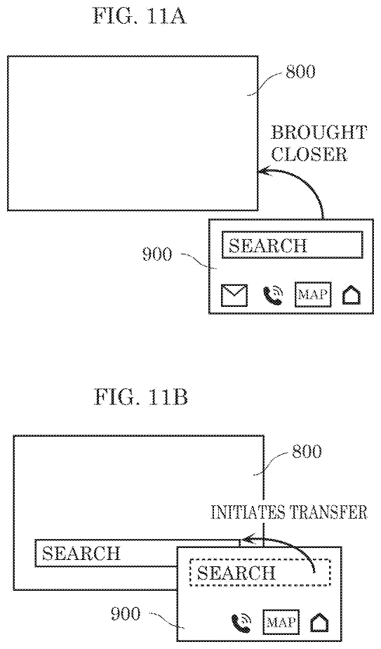

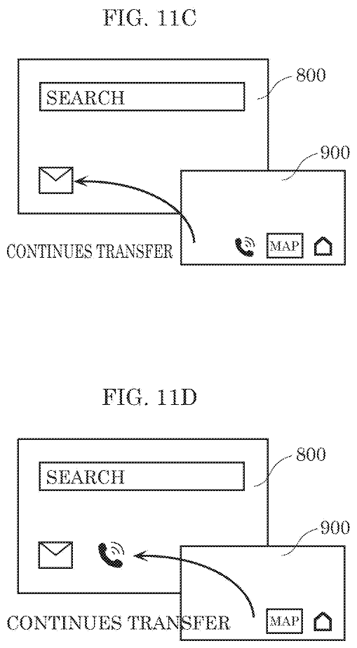

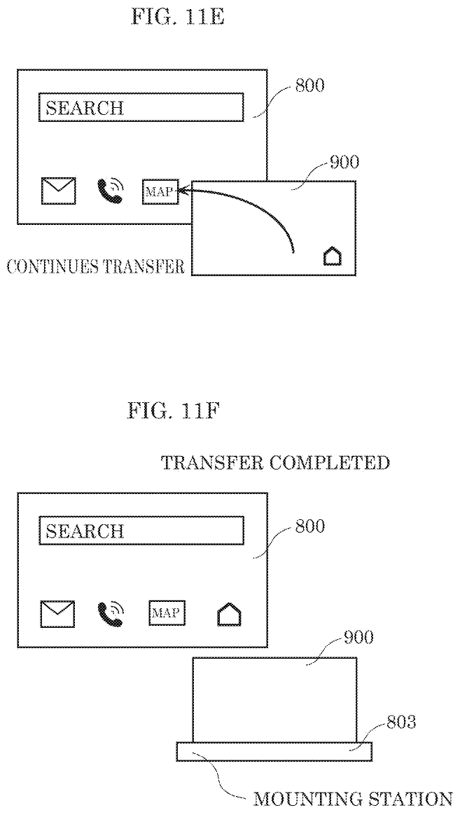

FIG. 11A to FIG. 11D illustrate an example display change of Embodiment 2. When Mini Panel 900 is brought closer to Big Panel 800 from downward as illustrated in FIG. 11A, and the upper portion of Mini Panel 900 that displays, for example, a graphic object partially overlaps with Big Panel 800, the graphic object (e.g., Search icon) will be displayed on lower portion of Big Panel 800 (FIG. 11B). Then, when the lower portion of Mini Panel 900 that displays a plurality of graphic objects partially overlaps with Big Panel 800, one of the graphic objects (e.g., Mail icon) will be displayed on the lower left portion of Big Panel 800 and it will be deleted from Mini Panel 900 (FIG. 11C). The graphic object (e.g., Search icon) will be moved to the upper portion of Big Panel 800. Then, another one of the graphic objects (e.g., Telephone icon) will be displayed on the lower middle portion of Big Panel 800 and it will be deleted from Mini Panel 900 (FIG. 11D). Next, another one of the graphic objects (e.g., Map icon) will be displayed on the lower middle portion of Big Panel 800 and it will be deleted from Mini Panel 900 (FIG. 11E). Then, last one of the graphic objects (e.g., House icon) will be displayed on the lower right portion of Big Panel 800 and it will be deleted from Mini Panel 900 (FIG. 11F). When Mini Panel 900 is mounted on mounting station 803 and all of the graphic objects (icons) are deleted from Mini Panel 900, the transfer of graphic objects is completed.

It should be noted that because the deletion of the graphic objects is optional similar to Embodiment 1, some of the graphic objects, such as a search icon, that are originally displayed on Mini Panel 900 can remain on the display of Mini Panel 900 in the above described example display changes (FIG. 11A to FIG. 11F).

When Mini Panel 900 is brought closer to Big Panel 800 from upward, the transfer of graphic objects is initiated from the lower portion of Mini Panel 900. In the example of FIG. 11A, the one of the graphic objects (e.g., Mail icon) will be displayed on the upper left portion of Big Panel 800 and it will be deleted from Mini Panel 900. Then, another one of the graphic objects (e.g., Telephone icon) will be displayed on the upper middle portion of Big Panel 800 and it will be deleted from Mini Panel 900. The rest of the transfer is similar to the example of FIG. 11B to FIG. 11F except that the transfer of the Search icon is performed last and the other icons will be moved to upper portion of Big Panel 800.

It should be noted that because the deletion of the graphic objects is optional similarly to Embodiment 1, some of the graphic objects, such as a search icon, that are originally displayed on Mini Panel 900 can remain on the display of Mini Panel 900 in the above described example display changes.

Further, a size and shape of each one of the graphic objects after the transfer may be the same as or different from its original size and shape before the transfer. The size and shape may be adjusted according to the display size of Big Panel 800 to enhance visibility to the user. And the positional relationship of the graphic objects after the transfer can be the same as or different from its original locations on Mini Panel 900.

According to the above described Embodiment 2, graphic objects (UIs) displayed on Mini Panel 900 are transferred to Big Panel 800, thus facilitating to provide a display apparatus that can display graphic objects in a seamless manner. This enhances user experiences by extending the user's private space even when the user enters a work space, steps into a living room, or gets on a vehicle on a plane.

### Embodiment 3

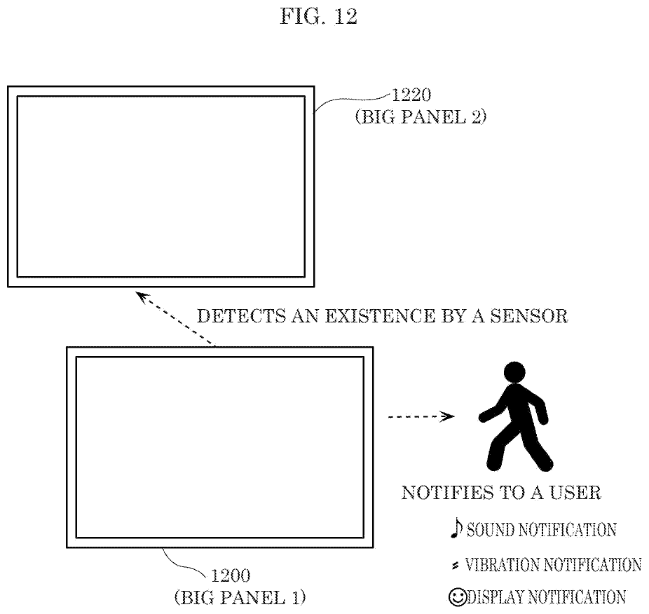

FIG. 12 illustrates an example interaction between display apparatus 1200 (Big Panel 1) and another display apparatus 1220 (Big Panel 2) of Embodiment 3. In this embodiment, the display size of the two display apparatus is the same. The display size can be determined by the length of the sides or area of the display.

Since the structure of display apparatus 1200 is the same as that of display apparatus 100 in Embodiment 1, and the method of transfer of graphic objects is the same as described in Embodiment 1, detailed description is omitted for brevity of explanation. The term “Big Panel” and “Mini Panel” in Embodiment 1 are replaced by the term “Big Panel 1” and “Big Panel 2,” respectively in this embodiment.

According to the above described Embodiment 3, graphic objects (UIs) displayed on Big Panel 2 are transferred to Big Panel 1, thus facilitating to provide a display apparatus that can display graphic objects in a seamless manner. This decreases confusion and inconvenience of the user and enhances user experience when using a semi-fixed display panel and the user's portable display apparatus at the same time.

Further, a size and shape of each one of the graphic objects after the transfer may be the same as or different from its original size and shape before the transfer. And the positional relationship of the graphic objects after the transfer can be the same as or different from its original locations on the Mini Panel.

It should be noted that the scope of this disclosure is not limited to the above described embodiments. The above described embodiments can be combined.

### <Example Structure of Display Apparatus>

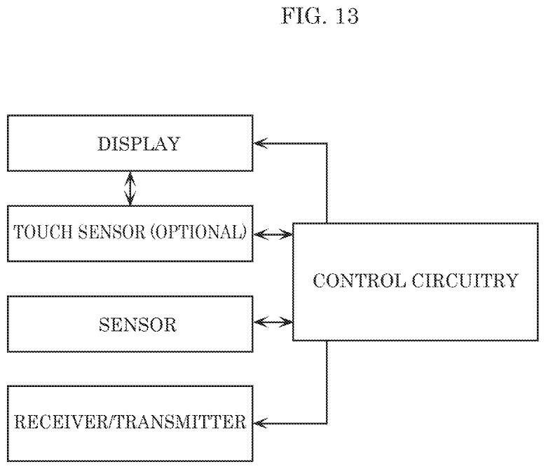

FIG. 13 illustrates an example structure of the display apparatus (100, 800 and 1200) of Embodiments 1, 2, 3. The display apparatus of FIG. 13 includes a display, a sensor, a receiver and transmitter, and control circuitry. If the display is a touch screen, the display apparatus may further include a touch sensor.

The display can be composed of a known display such as a CRT display, a liquid crystal display (LCD), a plasma display and organic electro luminescence (EL) display. The sensor can be composed of any type of sensor including an infrared sensor, radar, a photo sensor or other known techniques. The receiver and transmitter can be one or more antennas to receive and transmit signals from another electronic apparatus wirelessly. The control circuitry can be a processor that can control function of the display apparatus.

It should be noted that the scope of this disclosure is not limited to the above described embodiments and structures. The above described embodiments and structures can be combined.

The present disclosure can be realized by software, hardware, or software in cooperation with hardware. Each functional block used in the description of each embodiment described above can be realized by an LSI such as an integrated circuit, and each process described in each embodiment may be controlled by LSI. They may be individually formed as chips, or one chip may be formed so as to include a part or all of the functional blocks. They may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit or a general-purpose processor. In addition, a FPGA (Field Programmable Gate Array) that can be programmed after the manufacture of the LSI or a reconfigurable processor in which the connections and the settings of circuits cells disposed inside the LSI can be reconfigured may be used.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

What is claimed is:

1. A display apparatus, comprising:
a housing;
a display panel attached to the housing;
a sensor located in the housing, which, in operation, detects an existence of an other display apparatus; and
control circuitry located in the housing, which, in operation, controls:
notifying a user of the display apparatus of the detected existence of the other display apparatus by at least one of a sound notification, a vibration notification, and a visual notification; and
initiating transfer of graphic objects that are displayed on a display of the other display apparatus to the display panel when a distance from the display apparatus to the other display apparatus is less than or equal to a first threshold value, wherein
the transfer of the graphic objects includes:
displaying one of the graphic objects on the display panel; and
having the one of the graphic objects deleted from the display of the other display apparatus.

2. The display apparatus according to claim 1, wherein
each of the graphic objects include at least one of a graphic icon, a text message, a picture, a graphical illustration, and a combination thereof, and the transfer of the graphic objects is performed in graphic object unit.

3. The display apparatus according to claim 1, wherein
the transfer of the graphic objects is performed by displaying on the display panel one or more graphic objects that become invisible by the display apparatus.

4. The display apparatus according to claim 1, wherein
a size and a shape of each of the graphic objects after the transfer are different from an original size and an original shape of the graphic object before the transfer.

5. The display apparatus according to claim 1, wherein
the transfer of the graphic objects is completed when the display apparatus is mounted in front of or over the other display apparatus.

6. The display apparatus according to claim 1, wherein
the display panel includes at least a first portion and a second portion,
the display of the other display apparatus includes at least a third portion and a fourth portion,
when the sensor detects that the fourth portion is covered by the display apparatus, one graphic object displayed on the fourth portion is displayed on the first portion of the display panel, and
when the sensor further detects that the third portion is also covered by the display apparatus, the one graphic object is moved to be displayed on the second portion of the display panel, and an other graphic object displayed on the third portion is displayed on the first portion of the display panel.

7. The display apparatus according to claim 1, wherein
a display size of the display apparatus is bigger than or equal to a display size of the other display apparatus, and
when the display apparatus is mounted in front of or over the other display apparatus, all of the graphic objects are displayed on the display panel.

8. The display apparatus according to claim 1, wherein
a display size of the display apparatus is smaller than a display size of the other display apparatus, and
when the display apparatus is placed in front of the other display apparatus, one or more of the graphic objects are displayed on the display panel and a remainder of the graphic objects remains displayed on the display of the other display apparatus.

9. The display apparatus according to claim 1, wherein
the other display apparatus is attached to a wall or a floor and the display apparatus can be mounted in front of and held away from the other display apparatus.

10. The display apparatus according to claim 1, wherein
the display apparatus is attached to or placed against a wall or a floor and the other display apparatus can be mounted in front of and held away from the display apparatus.

11. A display control method for a display apparatus including a display panel, the display control method comprising:
detecting an existence of an other display apparatus;
notifying a user of the display apparatus of the detected existence of the other display apparatus by at least one of a sound notification, a vibration notification, and a visual notification; and
initiating transfer of graphic objects that are displayed on a display of the other display apparatus to the display panel when a distance from the display apparatus to the other display apparatus is less than or equal to a first threshold value, wherein
the transfer of the graphic objects includes:
displaying one of the graphic objects on the display panel; and
having the one of the graphic objects deleted from the display of the other display apparatus.
